(19) United States
(12) Patent Application Publication
(10) Pub. No.: US 2010/0149816 A1
(43) Pub. Date: Jun. 17, 2010

(54) LIGHT EMITTING MODULE, FABRICATION METHOD THEREFOR, AND LAMP UNIT

(75) Inventors: Yuji Higashi, Shizuoka (JP); Shogo Sugimori, Shizuoka (JP); Masanobu Mizuno, Shizuoka (JP); Tetsuya Suzuki, Shizuoka (JP); Yasutaka Sasaki, Shizuoka (JP); Tomoyuki Nakagawa, Shizuoka (JP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: KOITO MANUFACTURING CO., LTD., Tokyo (JP)

(21) Appl. No.: 12/637,678

(22) Filed: Dec. 14, 2009

(30) Foreign Application Priority Data
Dec. 15, 2008 (JP) 2008-318976

(51) Int. Cl. F21V 9/00; B23P 11/00

(52) U.S. Cl. 362/293; 29/428

(57) ABSTRACT

In a light emitting module, an electrode receiving the supply of current for light emission is provided on the light emitting surface of a semiconductor light emitting device. A light wavelength conversion member is a plate-like material mounted on the light emitting surface and emits light after converting a wavelength of the light emitted by the light emitting element. The light wavelength conversion member has a notch such that at least a part of the electrode communicates with the external space in a manner perpendicular to the light emitting surface of the semiconductor device when the light wavelength conversion member is mounted on the light emitting surface.

### CROSS-REFERENCE TO RELATED APPLICATION

This application is based upon and claims the benefit of priority from the prior Japanese Patent Application No. 2008-318976, filed on Dec. 15, 2008, the entire content of which is incorporated herein by reference.

### BACKGROUND OF THE INVENTION

1. Field of the Invention

The present invention relates to a light emitting module, a fabrication method therefor, and a lamp unit provided with the light emitting module.

2. Description of the Related Art

Recent years have seen continuing development of technologies concerning light emitting modules using light emitting elements, such as LEDs (Light Emitting Diodes), as the light source for emitting strong light. An example of an application is lamp units irradiating the front area of a vehicle. And the purpose of the development has been to achieve longer lifetime and lower power consumption for such lamps. Those applications, however, have required the light emitting modules to have high luminance or luminosity.

Thus proposed to enhance the extraction efficiency of white light, for instance, have been illumination apparatuses which comprise a light emitting element mainly emitting blue light, a yellow fluorescent material emitting mainly yellow light through excitation by blue light, and a blue-transmitting yellow-reflecting means which reflects light of wavelengths above the yellow light from the yellow fluorescent material while allowing the transmission therethrough of the blue light from the light emitting element (See Reference (1) in the following Related Art List). Also, proposed to raise the conversion efficiency, for instance, has been a structure having a ceramic layer which is disposed in the path of light released by a light emitting layer (See Reference (2), for instance).

### RELATED ART LIST

(1) Japanese Patent Application Publication No. 2007-59864.
(2) Japanese Patent Application Publication No. 2006-5367.

A light emitting element, such as an LED, has an electrode provided on a emission surface, and Au wire or the like is sometimes bonded on the electrode. In such a case, for the placement of bonded wire, it is necessary that at least a part of the electrode communicates with the external space. On the other hand, the uses of LEDs have been rapidly expanding in recent years, so that measures must be taken to adequately meet the increasing volumes of production of LEDs and light emitting modules incorporating them. Hence, it is a pressing need to simplify the fabrication process of light emitting modules incorporating LEDs.

### SUMMARY OF THE INVENTION

The present invention has been made to resolve the foregoing problems, and a purpose thereof is to provide a light emitting module that can be fabricated by a simple process even when the light emitting element employed is of a type having the electrode on the emission surface thereof.

In order to resolve the above problems, a light emitting module according to an embodiment of the present invention comprises: a light emitting element having a light emitting surface on which a conductive portion receiving the supply of current for light emission is disposed; and a light wavelength conversion member which is a plate-like material mounted on the light emitting surface and emits light after converting a wavelength of the light emitted by the light emitting element. The light wavelength conversion member is formed such that at least a part of the conductive portion communicates with an external space when the light wavelength conversion member is mounted on the light emitting surface.

Another embodiment of the present invention relates to a method of fabricating a light emitting module. This method comprises: forming a light wavelength conversion member, which converts the wavelength of light emitted by a light emitting element, in such a manner that when a conductive portion receiving the supply of current for light emission is mounted on a light emitting surface of the light emitting element provided on the light emitting surface, at least a part of the conductive portion communicates with an external space; and mounting the light wavelength conversion member on the light emitting surface in such a manner that at least a part of the conductive portion communicates with the external space.

Still another embodiment of the present invention relates to a lamp unit. This lamp unit comprises: a light emitting module including a light emitting element having a light emitting surface on which a conductive portion receiving the supply of current for light emission is disposed, and a light wavelength conversion member which is a plate-like material mounted on the light emitting surface and emits light after converting a wavelength of the light emitted by the light emitting element; and an optical element configured to collect the light emitted by the light emitting module. The light wavelength conversion member is formed such that at least a part of the conductive portion communicates with an external space when the light wavelength conversion member is mounted on the light emitting surface.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a cross-sectional view showing a structure of an automotive headlamp according to a first embodiment of the present invention;

FIG. 2 illustrates a structure of a light emitting module board according to a first embodiment;

FIG. 3 is a perspective view showing a structure of a light emitting module according to a first embodiment;

FIG. 4 is a perspective view showing a structure of a light emitting module according to a second embodiment of the present invention;

FIG. 5A is a perspective view showing a structure of a light emitting module according to a third embodiment of the present invention;

FIG. 5B is a cross-sectional view taken along a cross section S1 of a light emitting module shown in FIG. 5A;

FIG. 6A is a perspective view showing a structure of a light emitting module according to a fourth embodiment of the present invention;

FIG. 6B is a cross-sectional view taken along a cross section S2 of a light emitting module shown in FIG. 6A;

FIG. 7A is a perspective view showing a structure of a light emitting module according to a fifth embodiment of the present invention;

FIG. 7B is a cross-sectional view as viewed from a viewpoint P shown in FIG. 7;

FIG. 8 is a perspective view showing a structure of a light emitting module according to a sixth embodiment of the present invention; and

FIG. 9 illustrates a state which is before a material from which the light wavelength conversion member is fabricated is subjected to a dicing process.

### DETAILED DESCRIPTION OF THE INVENTION

The invention will now be described by reference to the preferred embodiments. This does not intend to limit the scope of the present invention, but to exemplify the invention.

Hereinbelow, the embodiments will now be described in detail with reference to drawings.

### First Embodiment

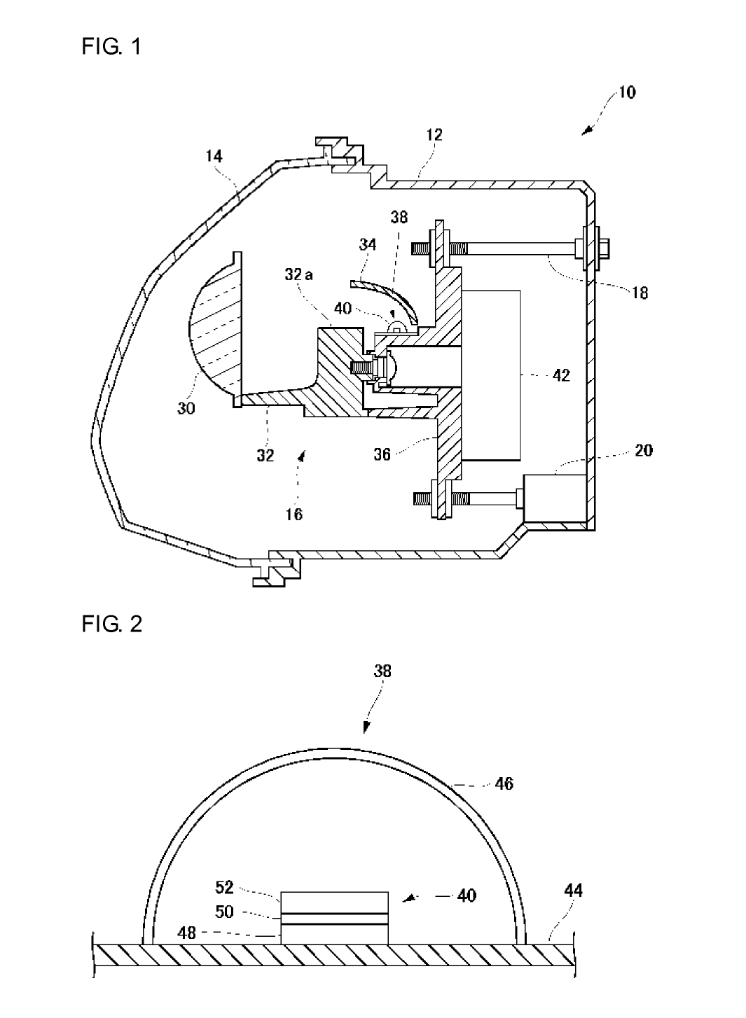

FIG. 1 is a cross-sectional view of automotive headlamp according to a first embodiment of the present invention. An automotive headlamp 10 includes a lamp body 12, a front face cover 14, and a lamp unit 16. A description is hereinbelow given in a such a manner that the left side of FIG. 1 is treated as a front part of the lamp unit, whereas the right side of FIG. 1 is treated as a rear part of the lamp unit. Also, a right side as viewed toward the front part of the lamp unit is called a right side of the lamp unit, whereas a left side as viewed toward the front part thereof is called a left side of the lamp unit. FIG. 1 is a cross-sectional view of the automotive lamp 10 cut along the vertical plane including the optical axis of the lamp unit 16, as viewed from the left side of the lamp unit. When the automotive headlamp 10 is mounted on a vehicle, the automotive headlamps 10, which are formed bilaterally symmetrical to each other, are disposed in a left-side front part of the vehicle and a right-side front part thereof, respectively. FIG. 1 illustrates either one of such left and right automotive headlamps 10.

The lamp body 12 is formed in a box-like shape having an opening. The front face cover 14 is formed, in a bowl-like shape, of resin or glass having translucency. Peripheral part of the front face cover 14 is fit to the opening of the lamp body 12. In this manner, a lamp chamber is formed in a region covered by the lamp body 12 and the front face cover 14.

The lamp unit 16 is placed within the lamp chamber. The lamp unit 16 is fixed to the lamp body 12 with aiming screws 18. A lower aiming screw 18 is structured such that it rotates when a leveling actuator 20 is actuated. Thus, with the leveling actuator 20 actuated, the optical axis of the lamp unit 16 is movable vertically.

The lamp unit 16 includes a projection lens 30, a support member 32, a reflector 34, a bracket 36, a light emitting module substrate 38, and a heat radiation fin 42. The projection lens 30 is a plano-convex aspheric lens, having a convex front surface and a plane rear surface, which projects a light source image formed on a rear focal plane toward a front area of the lamp as a reverted image. The support member 32 supports the projection lens 30. A light emitting module 40 is disposed on the light emitting module substrate 38. The reflector 34 reflects light from the light emitting module 40 and forms the light source image on the rear focal plane of the projection lens 30. In this manner, the reflector 34 and the projection lens 30 function as optical elements that collect the light emitted by the light emitting module 40. The heat radiation fin 42, which is fit on a rear-side surface of the bracket 36, radiates the heat generated mainly by the light emitting module 40.

A shade 32a is formed in the support member 32. The automotive headlamp 10 is used as a low-beam light source. And the shade 32a shades part of light which is emitted from and light emitting module 40 and then reflected by the reflector 34, thereby forming cut-off line in a low-beam light distribution pattern in the frontward direction of a vehicle. Since the low-beam distribution pattern is known, the description thereof is omitted here.

FIG. 2 illustrates a structure of a light emitting module board 38 according to the first embodiment. The light emitting module board 38 includes a light emitting module 40, a substrate 44, and a transparent cover 46. The substrate 44, which is a printed-circuit board, has the light emitting module 40 mounted on the top surface thereof. The light emitting module 40 is covered by the colorless transparent cover 46.

The light emitting module 40 is disposed in a stack of a semiconductor light emitting device 48, an intermediate member 50, and a light wavelength conversion member 52. More specifically, the semiconductor light emitting device 48 is mounted directly to the substrate 44, and the intermediate member 50 and the light wavelength conversion member 52 are stacked on top of the light emitting device 48 in this order.

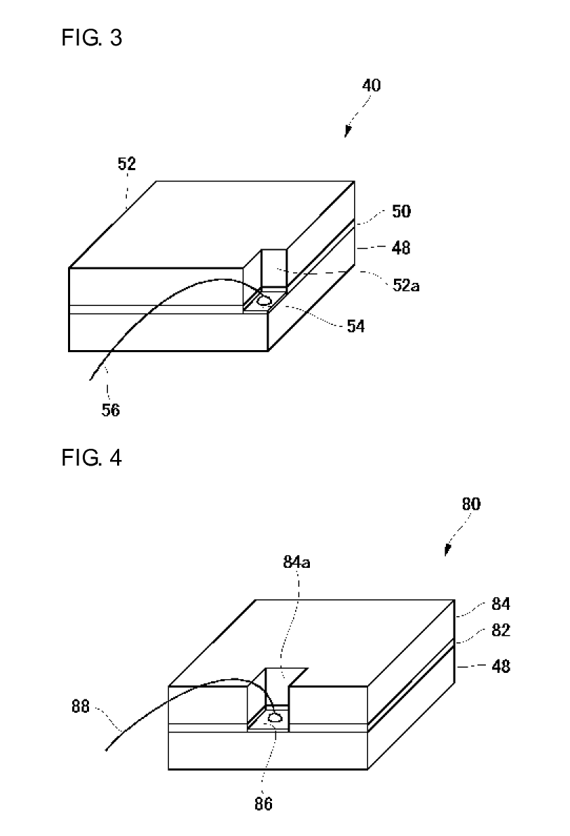

FIG. 3 is a perspective view showing a structure of a light emitting module 40 according to the first embodiment. A semiconductor light emitting device 48 is formed of an LED element. In the first embodiment, the semiconductor light emitting device 48 employed is a blue LED which emits light of mainly the wavelengths of blue light. More specifically, the semiconductor light emitting device 48 is constructed of an InGaN LED element which is formed through crystal growth of an InGaN semiconductor layer. The semiconductor light emitting device 48 is formed as a 1 mm square chip, for instance, and is disposed such that the center wavelength of the emitted blue light is 470 nm. It should be noted that the structure of the semiconductor light emitting device 48 and the wavelengths of light emitted thereby are not limited to those described above.

The semiconductor light emitting device 48 as described in the first embodiment is a vertical chip type. The vertical chip type semiconductor light emitting device 48 has an n-type electrode formed on the face where it is mounted on the substrate, and stacked on top thereof are an n-type semiconductor, a p-type semiconductor, and a p-type electrode. Accordingly, an electrode 54, which is an electrically conductive body, or the p-type electrode, is provided on the top surface of the semiconductor light emitting device 48, i.e., the light emitting surface thereof. Since the semiconductor light emitting device 48 such as described above is publicly known, further description thereof is omitted. It should be noted also that the semiconductor light emitting device 48 is not limited to the vertical chip type.

An Au wire 56 is bonded on the electrode 54. Through this Au wire 56, current necessary for light emission is supplied to the electrode 54. Note that aluminum wire, copper foil or aluminum ribbon wire, for instance, may be used instead of the Au wire 56.

The light wavelength conversion member 52 is made of a so-called light emitting ceramic or fluorescent ceramic obtainable by sintering a ceramic green body prepared from yttrium aluminum garnet (YAG) powder, which is a fluorescent material that can be excited by blue light. Since the fabrication method of a light wavelength conversion ceramic such as described above is publicly known, detailed description thereof is omitted.

The light wavelength conversion member 52 thus obtained emits yellow light by converting the wavelength of blue light that is mainly emitted by the semiconductor light emitting device 48. Hence, the light emitting module 40 emits light which is synthesized from the blue light having been directly transmitted through the light wavelength conversion member 52 and the yellow light produced through wavelength conversion by the light wavelength conversion member 52. In this manner, white light can be emitted from the light emitting module 40.

The light wavelength conversion member 52 employed is a transparent one. The term “transparent” as used in the first embodiment is understood to mean a state where the transmission rate of all the light in the converted wavelength band is 40% or above. Through earnest and diligent R&D efforts of the inventors, it has been confirmed that the state of transparency where the transmission rate of all the light in the converted wavelength band is 40% or above makes it possible not only to properly convert the wavelengths of light by the light wavelength conversion member 52 but also to properly reduce the drop in the luminosity of light passing through the light wavelength conversion member 52. Accordingly, the light emitted by the semiconductor light emitting device 48 can be more efficiently converted by the selection of transparency of the light wavelength conversion member 52 as described above.

The light wavelength conversion member 52 is formed of a binderless inorganic substance, so that it displays improved durability compared with those containing organic matter such as a binder. Accordingly, it is possible to apply an electric power of 1 watt (W) or above, for instance, to the light emitting module 40, which helps raise the luminance and luminosity of the light emitted thereby.

It should be noted that as the semiconductor light emitting device 48, one which mainly emits light of wavelengths other than those of blue may be employed. In such a case, too, as the light wavelength conversion member 52, one which converts the wavelengths of the main light emitted by the semiconductor light emitting device 48 is employed. Even in this case, the light wavelength conversion member 52 may convert the wavelengths of the light emitted by the semiconductor light emitting device 48 in such a manner that white or a color having wavelengths close to those of white may be produced through combination with the wavelengths of light mainly emitted by the semiconductor light emitting device 48.

The intermediate member 50 is formed of a material with a refractive index lower than that of the light wavelength conversion member 52, so that the light emitted by the semiconductor light emitting device 48 can enter the light wavelength conversion member 52 smoothly. The intermediate member 50 is formed through solidification of a viscous or flexible material, such as an adhesive, after it is sandwiched between the light emitting surface of the semiconductor light emitting device 48 and the incident surface of the light wavelength conversion member 52.

The light wavelength conversion member 52 is a plate-like member in a rectangular form similar to that of the light emitting surface of the semiconductor light emitting device 48. Provided in a corner of the light emitting surface of the semiconductor light emitting device 48 is an electrode 54 to which electric current for light emission is supplied. The light wavelength conversion member 52 has in a corner thereof a rectangular notch 52a rectangular in shape which runs from the incident surface to the emission surface thereof. Consequently, when the light wavelength conversion member 52 is mounted on the light emitting surface of the semiconductor light emitting device 48, a part of the electrode 54 communicates with the external space in such a manner as to be perpendicular to the light emitting surface of the semiconductor light emitting device 48. And this arrangement makes the placement of Au wire 56 easier.

In the fabrication of a light emitting module 40, a light wavelength conversion material larger in area than the light emitting surface of the semiconductor light emitting device 48 is first cut into rectangles by dicing. Then the light wavelength conversion member 52 is formed by cutting a corner thereof into a notch 52a by a laser process or the like. It goes without saying that the cutting process is not limited to the laser process. In its place, any of such processes as water cutter process, preforming by molding, etching, drilling and wire saw process may be used.

The Au wire 56 is bonded on the electrode 54 before the light wavelength conversion member 52 is placed above the light emitting surface of the semiconductor light emitting device 48. Accordingly, a wide space is provided over the light emitting surface of the semiconductor light emitting device 48, so that the Au wire 56 can be bonded easily. It should be noted, however, that the Au wire 56 may be bonded on the electrode 54 after the light wavelength conversion member 52 is mounted over the light emitting surface of the semiconductor light emitting device 48.

Next, the light wavelength conversion member 52, with a pre-solidification intermediate member 50 applied on the incident surface thereof, is mounted on the light emitting surface of the semiconductor light emitting device 48. At this time, the light wavelength conversion member 52 is positioned so that the notch 52a comes above the electrode 54 and a part of the electrode 54 communicates with the external space. In this manner, the light wavelength conversion member 52 is fixed to the light emitting surface of the semiconductor light emitting device 48 putting the intermediate member 50 therebetween. Thus, a notch 52a formed beforehand in the light wavelength conversion member 52 realizes fabrication of the light emitting module in a simpler process than when, for instance, a powdery fluorescent material is stacked on the light emitting surface of the semiconductor light emitting device 48.

### Second Embodiment

FIG. 4 is a perspective view showing a structure of a light emitting module 80 according to a second embodiment of the present invention. Note that the structure of the automotive headlamp 10 is the same as that of the first embodiment except that the light emitting module 80 is used in the place of the light emitting module 40. Hereinbelow, the components identical to those of the first embodiment are given the identical reference numerals, and the repeated description thereof will be omitted.

The light emitting module 80 is constructed of a light wavelength conversion member 84 mounted on the light emitting surface of the semiconductor light emitting device 48 through an intermediate member 82. The material of the intermediate member 82 is the same as that of the aforementioned intermediate member 50, and the material of the light wavelength conversion member 84 is the same as that of the aforementioned light wavelength conversion member 52. Provided on the light emitting surface of the semiconductor light emitting device 48 is an electrode 86 to which electric current for light emission is supplied. And an Au wire 88 is bonded on the electrode 86. In the second embodiment, the electrode 86 is disposed such that the outer edges thereof are approximately aligned with the middle portion of an outer edge of the light emitting surface of the semiconductor light emitting device 48.

The light wavelength conversion member 84 is a plate-like member in a rectangular form similar to that of the light emitting surface of the semiconductor light emitting device 48. The light wavelength conversion member 84, too, is formed such that when it is mounted on the light emitting surface of the semiconductor light emitting device 48, a part of the electrode 86 communicates with the external space in such a manner as to be perpendicular to the light emitting surface of the semiconductor light emitting device 48. More specifically, the light wavelength conversion member 84 has midway in an edge thereof a notch 84a which is a rectangular recess running from the incident surface to the emission surface thereof. This notch 84a is located in such a position that when the light wavelength conversion member 84 is mounted on the light emitting surface of the semiconductor light emitting device 48, a part of the electrode 86 is exposed to the external space. The notch 84a thus located makes easier the placement of Au wire 88, which is bonded on the electrode 86.

In the fabrication of a light emitting module 80, a light wavelength conversion material larger in area than the light emitting surface of the semiconductor light emitting device 48 is first cut into rectangles by dicing in the same manner as in the first embodiment. Then the notch 84a is formed in the light wavelength conversion member 84 by cutting out the midway portion in an edge of the light wavelength conversion member 84 by the laser process or the like.

The Au wire 88 is bonded on the electrode 86 before the light wavelength conversion member 84 is placed. Then the light wavelength conversion member 84, with a pre-solidification intermediate member 82 applied on the incident surface thereof, is mounted on the light emitting surface of the semiconductor light emitting device 48. At this time, the light wavelength conversion member 84 is positioned so that the notch 84a comes above the electrode 86 and a part of the electrode 86 communicates with the external space. In this manner, the light wavelength conversion member 84 is fixed to the light emitting surface of the semiconductor light emitting device 48 putting the intermediate member 82 between t them. In the second embodiment, too, the light emitting module can be fabricated by a simple process. It should be noted, however, that the Au wire 88 may be bonded on the electrode 86 after the light wavelength conversion member 84 is mounted over the light emitting surface of the semiconductor light emitting device 48.

### Third Embodiment

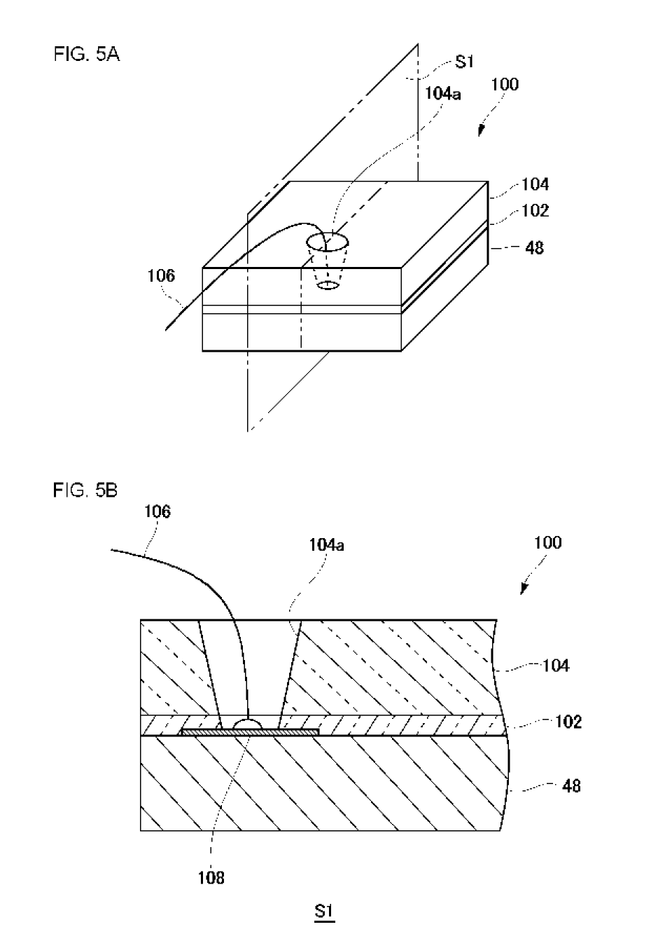

FIG. 5A is a perspective view showing a structure of a light emitting module 100 according to a third embodiment of the present invention. FIG. 5B is a cross-sectional view taken along a cross section S1 of the light emitting module 100 shown in FIG. 5A. Note that the structure of the automotive headlamp 10 is the same as that of the first embodiment except that the light emitting module 100 is used in the place of the light emitting module 40. Hereinbelow, the components identical to those of the first embodiment are given the identical reference numerals, and the repeated description thereof will be omitted.

The light emitting module 100 is constructed of a light wavelength conversion member 104 mounted on the light emitting surface of the semiconductor light emitting device 48 through an intermediate member 102. The material of the intermediate member 102 is the same as that of the aforementioned intermediate member 50, and the material of the light wavelength conversion member 104 is the same as that of the aforementioned light wavelength conversion member 52. Provided on the light emitting surface of the semiconductor light emitting device 48 is an electrode 108 to which electric current for light emission is supplied. And an Au wire 106 is bonded on the electrode 108. In the third embodiment, the electrode 108 is so located as to be slightly closer to the center of the semiconductor light emitting device 48 away from the outer edge thereof such that the outer edge of the electrode 108 is not aligned with that of the semiconductor light emitting device 48.

The light wavelength conversion member 104 is a plate-like member in a rectangular form similar to that of the light emitting surface of the semiconductor light emitting device 48. The light wavelength conversion member 104, too, is formed such that when it is mounted on the light emitting surface of the semiconductor light emitting device 48, a part of the electrode 108 communicates with the external space in such a manner as to be perpendicular to the light emitting surface of the semiconductor light emitting device 48. More specifically, a circular opening 104a, which runs from the incident surface to the emission surface of the light wavelength conversion member 104, is formed therein. This opening 104a is located in such a position that when the light wavelength conversion member 104 is mounted on the light emitting surface of the semiconductor light emitting device 48, a part of the electrode 108 communicates with the external space. The opening 104a is formed such that the diameter thereof increases gradually from the incident surface to the emission surface of the light wavelength conversion member 104. The opening 104a provided in this manner makes easier the placement of the Au wire 106, which is bonded on the electrode 108.

In the fabrication of a light emitting module 100, a light wavelength conversion material larger in area than the light emitting surface of the semiconductor light emitting device 48 is first cut into rectangles by dicing in the same manner as in the first embodiment. Then the opening 104a is provided using the laser process or the like, thereby forming the light wavelength conversion member 104.

The Au wire 106 is bonded on the electrode 108 before the light wavelength conversion member 104 is placed. Then the light wavelength conversion member 104, with a pre-solidification intermediate member 102 applied on the incident surface thereof, is mounted on the light emitting surface of the semiconductor light emitting device 48. At this time, the already bonded electrode 108 is first positioned with the Au wire 106 passing through the opening 104a, and then the light wavelength conversion member 104 is positioned so that the opening 104a comes above the electrode 108 and a part of the electrode 108 communicates with the external space. In this manner, the light wavelength conversion member 104 is fixed to the light emitting surface of the semiconductor light emitting device 48 putting the intermediate member 102 therebetween. In this third embodiment, too, the light emitting module can be fabricated by a simple process. It should be noted, however, that the Au wire 106 may be bonded on the electrode 108 after the light wavelength conversion member 104 is mounted over the light emitting surface of the semiconductor light emitting device 48.

### Fourth Embodiment

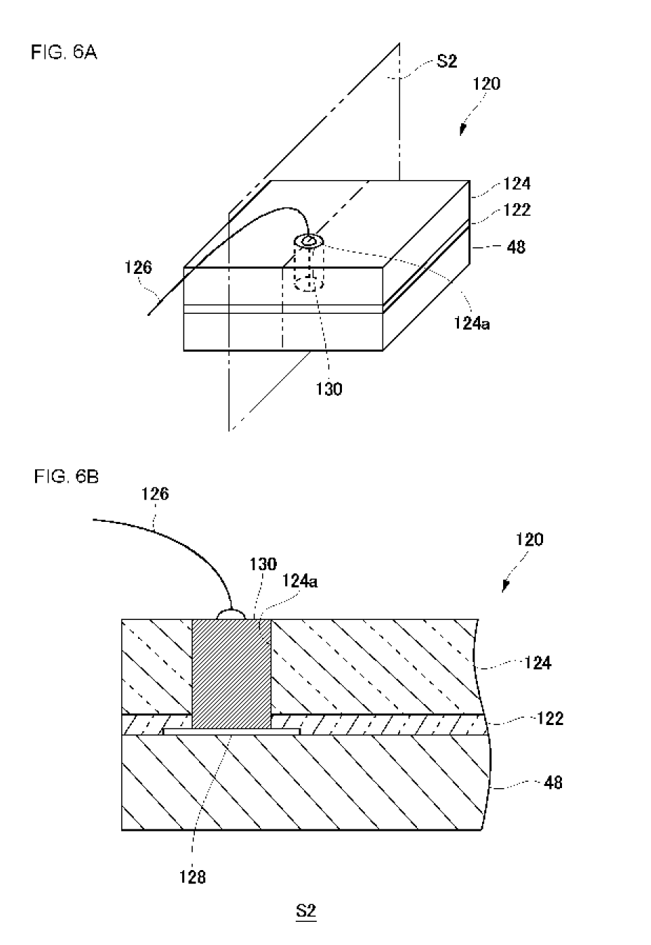

FIG. 6A is a perspective view showing a structure of a light emitting module 120 according to a fourth embodiment of the present invention. FIG. 6B is a cross-sectional view taken along a cross section S2 of the light emitting module 120 shown in FIG. 6A. Note that the structure of the automotive headlamp 10 is the same as that of the first embodiment except that the light emitting module 120 is used in the place of the light emitting module 40. Hereinbelow, the components identical to those of the first embodiment are given the identical reference numerals, and the repeated description thereof will be omitted.

The light emitting module 120 is constructed of a light wavelength conversion member 124 mounted on the light emitting surface of the semiconductor light emitting device 48 through an intermediate member 122. The material of the intermediate member 122 is the same as that of the aforementioned intermediate member 50, and the material of the light wavelength conversion member 124 is the same as that of the aforementioned light wavelength conversion member 52. Provided on the light emitting surface of the semiconductor light emitting device 48 is an electrode 128 to which electric current for light emission is supplied. In the fourth embodiment, the electrode 128 is so located as to be slightly closer to the center of the semiconductor light emitting device 48 away from the outer edge thereof such that the outer edge of the electrode 128 is not aligned with that of the semiconductor light emitting device 48.

The light wavelength conversion member 124 is a plate-like member in a rectangular form similar to that of the light emitting surface of the semiconductor light emitting device 48. A circular opening 124a, which runs from the incident surface to the emission surface of the light wavelength conversion member 124, is formed in the light wavelength conversion member 124. This opening 124a is located in such a position that when the light wavelength conversion member 124 is mounted on the light emitting surface of the semiconductor light emitting device 48, a part of the electrode 128 communicates with the external space.

In the fourth embodiment, this opening 124a is filled with a conductive member 130. The conductive member 130 used here may be gold (Au), silver (Ag), copper (Cu), solder, lead-free (Pb-free) solder, or the like. Since the opening 124a is filled with the conductive material 130, an Au wire 126 can be bonded on the conducive material 130 on the emission surface of the light wavelength conversion member 124. Accordingly, the Au wire 126 can be bonded easily.

Since, as described above, the Au wire 126 can be bonded on the emission surface of the light wavelength conversion member 124, the diameter of the opening 124a can be made relatively smaller. This suppresses the drop in area of the emission surface of the light wavelength conversion member 124, so that the drop in the luminosity of the light emitting module 120 due to the bonding of the Au wire 125 can be reduced.

In the fabrication of a light emitting module 120, a light wavelength conversion material larger in area than the light emitting surface of the semiconductor light emitting device 48 is first cut into rectangles by dicing in the same manner as in the first embodiment. Then the opening 124a is provided using the laser process or the like, thereby forming the light wavelength conversion member 124.

Next, the light wavelength conversion member 124, with a pre-solidification intermediate member 122 applied on the incident surface thereof, is mounted on the light emitting surface of the semiconductor light emitting device 48. The light wavelength conversion member 124 is fixed to the light emitting surface of the semiconductor light emitting device 48 putting the intermediate member 122 therebetween. At this time, the light wavelength conversion member 124 is positioned so that the opening 124a comes above the electrode 128 and a part of the electrode 128 communicates with the external space.

Next, the conductive member 130 fills the opening 124a, thereby conducting electricity between the electrode 128 and he conductive member 130. Then, the Au wire 126 is bonded on the top surface of the conductive member 130. In this fourth embodiment, too, the light emitting module can be fabricated by a simple process.

### Fifth Embodiment

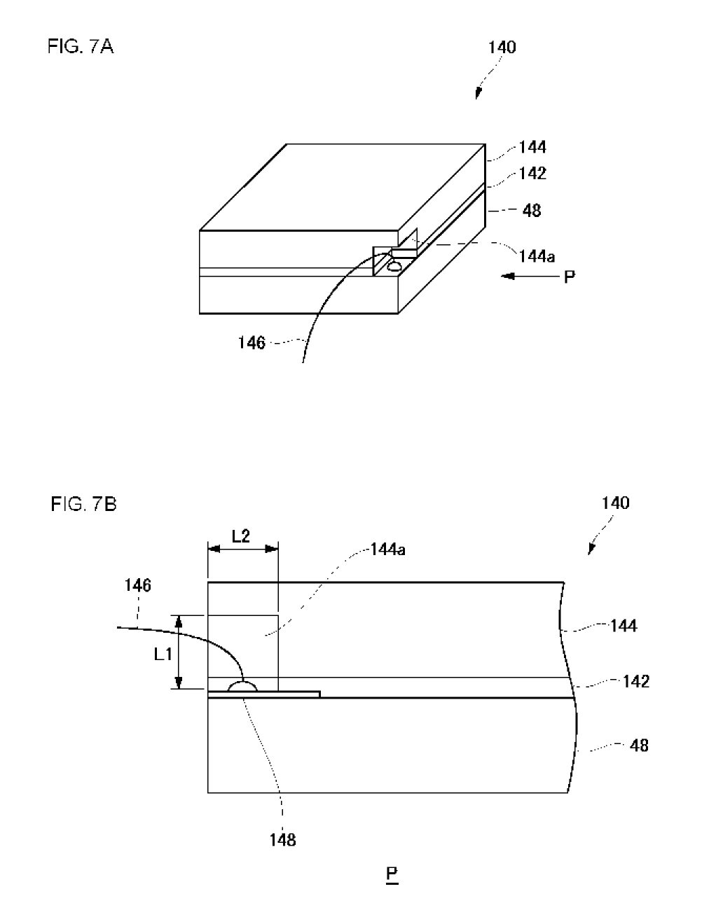

FIG. 7A is a perspective view showing a structure of a light emitting module 140 according to a fifth embodiment of the present invention. FIG. 7B is a cross-sectional view as viewed from a viewpoint P shown in FIG. 7. Note that the structure of the automotive headlamp 10 is the same as that of the first embodiment except that the light emitting module 140 is used in the place of the light emitting module 40. Hereinbelow, the components identical to those of the first embodiment are given the identical reference numerals, and the repeated description thereof will be omitted.

The light emitting module 140 is constructed of a light wavelength conversion member 144 mounted on the light emitting surface of the semiconductor light emitting device 48 through an intermediate member 142. The material of the intermediate member 142 is the same as that of the aforementioned intermediate member 50, and the material of the light wavelength conversion member 144 is the same as that of the aforementioned light wavelength conversion member 52. Provided on the light emitting surface of the semiconductor light emitting device 48 is an electrode 148 to which electric current for light emission is supplied. And an Au wire 146 is bonded on this electrode 148. In the fifth embodiment, the electrode 148 is provided in a corner of the light emitting surface of the semiconductor light emitting device 48.

The light wavelength conversion member 144 is a plate-like member in a rectangular form similar to that of the light emitting surface of the semiconductor light emitting device 48. The light wavelength conversion member 144 according to the fifth embodiment has a rectangular notch 144a such that the corner of the light wavelength conversion member 144 starting from the incident surface is not run up to the emission surface. Consequently, when the light wavelength conversion member 144 is mounted on the light emitting surface of the semiconductor light emitting device 48, a part of the electrode 148 communicates with the external space in such a manner as to be parallel to the light emitting surface of the semiconductor light emitting device 48. And this arrangement makes the placement of Au wire 146 easier.

In the fabrication of a light emitting module 140, a light wavelength conversion material larger in area than the light emitting surface of the semiconductor light emitting device 48 is first cut into rectangles by dicing. Then the notch 144a is provided by cutting a corner of the member, which has been cut and provided by dicing, using the laser process or the like.

The Au wire 146 is bonded on the electrode 148 before the light wavelength conversion member 144 is placed. Next, the light wavelength conversion member 144, with a pre-solidification intermediate member 142 applied on the incident surface thereof, is mounted on the light emitting surface of the semiconductor light emitting device 48. At this time, the light wavelength conversion member 144 is positioned so that the notch 144a comes above the electrode 148 and a part of the electrode 148 communicates with the external space. In this manner, the light wavelength conversion member 144 is fixed to the light emitting surface of the semiconductor light emitting device 48 putting the intermediate member 142 therebetween. In this fifth embodiment, too, the light emitting module can be fabricated by a simple process. It is to be noted that the Au wire 146 may be bonded on the electrode 148 after the light wavelength conversion member 144 is mounted over the light emitting surface of the semiconductor light emitting device 48.

### Sixth Embodiment

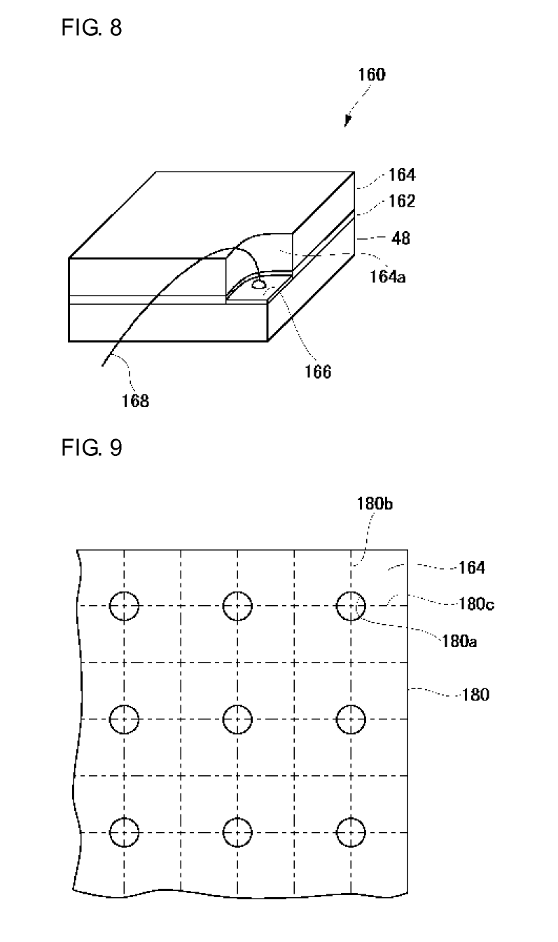

FIG. 8 is a perspective view showing a structure of a light emitting module 160 according to a sixth embodiment of the present invention. Note that the structure of the automotive headlamp 10 is the same as that of the first embodiment except that the light emitting module 160 is used in the place of the light emitting module 40. Hereinbelow, the components identical to those of the first embodiment are given the identical reference numerals, and the repeated description thereof will be omitted.

The light emitting module 160 is constructed of a light wavelength conversion member 164 mounted on the light emitting surface of the semiconductor light emitting device 48 through an intermediate member 162. The material of the intermediate member 162 is the same as that of the aforementioned intermediate member 50, and the material of the light wavelength conversion member 164 is the same as that of the aforementioned light wavelength conversion member 52. Provided on the light emitting surface of the semiconductor light emitting device 48 is an electrode 166 to which electric current for light emission is supplied. And an Au wire 168 is bonded on this electrode 166. In the sixth embodiment, the electrode 166 is provided in a corner of the light emitting surface of the semiconductor light emitting device 48.

The light wavelength conversion member 164 is a plate-like member in a rectangular form similar to that of the light emitting surface of the semiconductor light emitting device 48. The light wavelength conversion member 164 according to the fifth embodiment has a circular notch 164a, which runs from the incident surface to the emission surface thereof, in the corner. Consequently, when the light wavelength conversion member 164 is mounted on the light emitting surface of the semiconductor light emitting device 48, a part of the electrode 166 communicates with the external space in such a manner as to be perpendicular to the light emitting surface of the semiconductor light emitting device 48. And this arrangement makes the placement of Au wire 168 easier.

FIG. 9 illustrates a state which is before a material 180 from which the light wavelength conversion member 164 is fabricated is subjected to a dicing process. A description is now given of a process of the light wavelength conversion member 164 with reference to FIG. 9.

In the fabrication of a light emitting module 160, a material 180 which is a plate-like member in a rectangular form larger in area than the light wavelength conversion member 164 is first provided. Also, this material 180 is formed of a light wavelength conversion material that converts the wavelengths of the light emitted by the semiconductor light emitting device 48. A plurality of openings 180a, which are circular through-holes, are formed in this material 180. The plurality of openings 180a are placed side by side parallel to directions along the peripheries of the material 180 and are equally spaced from each other. More specifically, the openings 180a are spaced apart from each other with a distance therebetween equal to twice a side of the light wavelength conversion member 164. Each opening 180a is so formed as to have the same diameter as that of the notch 164 of the light wavelength conversion member 164. Each of the plurality of openings 180a may be produced by subjecting the plate-like material 180 to a machining process such as a laser process and a press forming. Also, the material 180a may be shaped using a mold, and the openings 180a may be shaped simultaneously with this shaping of the material 180.

Next, the material 180 is cut along a dicing line 180b and a dicing line 180c in such a manner that the cutting surface thereof contains the center of each opening 180a. As a result, the light wavelength conversion members 164 are provided. Providing a plurality of openings 180a in the material 180 in this manner allows a simplified fabrication process as compared with a case where after the material 180 is cut into fine members by dicing, the notch 164a is provided on each of the fine members thus cut. It goes without saying that the opening 180a is not limited to the circular through-hole and, for example, a rectangular opening or a bottomed hole which is thus not running all the way may also serve the purpose.

Also, the material 180 may be cut in such a manner that the cutting surface thereof does not contain the opening. In this case, the openings 180a are provided at intervals each having the side length of the light wavelength conversion member 164. This arrangement makes it possible to easily provide the openings 104a in the above-described third embodiment and the openings 124a in the above-described fourth embodiment, for example.

Now refer back to FIG. 8. The Au wire 168 is bonded on the electrode 166 before the light wavelength conversion member 164 is placed. Then the light wavelength conversion member 164, with a pre-solidification intermediate member 162 applied on the incident surface thereof, is mounted on the light emitting surface of the semiconductor light emitting device 48. At this time, the light wavelength conversion member 164 is positioned so that the notch 164a comes above the electrode 166 and a part of the electrode 166 communicates with the external space. In this manner, the light wavelength conversion member 164 is fixed to the light emitting surface of the semiconductor light emitting device 48 putting the intermediate member 102 therebetween. In this sixth embodiment, too, the light emitting module can be fabricated by a simple process. It should be noted, however, that the Au wire 168 may be bonded on the electrode 166 after the light wavelength conversion member 164 is mounted over the light emitting surface of the semiconductor light emitting device 48.

The present invention is not limited to each of the above-described embodiments only, and those resulting from any combination of the respective elements as appropriate are effective as embodiments. Also, it is understood by those skilled in the art that various modifications such as changes in design may be added to each of the embodiments based on their knowledge and the embodiments added with such modifications are also within the scope of the present invention. Such modification are described below.

In a modification, a so-called face-up type semiconductor light emitting device is used as the semiconductor light emitting device 48. In this face-up type semiconductor light emitting device, a sapphire substrate is provided on the face where it is mounted on the substrate 44, and stacked on top thereof is an n-type semiconductor. An n-type electrode is stacked on a part of this n-type semiconductor, and a p-type semiconductor and a p-type electrode are formed on another part of the top surface of the n-type semiconductor. In this case, at least two electrodes, namely the p-type electrode and the n-type electrode, are provided on the emission surface of the semiconductor light emitting device. Since the semiconductor light emitting device such as this face-up type is also publicly known, further description thereof is omitted.

When such a face-up type semiconductor light emitting device is used, a plurality of electrodes are provided on the light emitting surface of the semiconductor light emitting device 48. In this case, a plurality of openings or notches are provided in the light wavelength conversion member in each of the above-described embodiments such that when the light wavelength conversion member is mounted on the light emitting surface of the semiconductor light emitting device 48, at least a part of the plurality of openings or notches communicate with the external space. The openings or notches thus provided make easier the placement of a plurality of wires which are bonded on the respective electrodes, even when the plurality of electrodes are located on the light emitting surface of the semiconductor light emitting device.

In another modification, an optical filter is provided between the light emitting surface of the semiconductor light emitting device in each of the above-described embodiments and the incident surface of the light wavelength conversion member therein. The optical filter transmits the blue light mainly produced by the semiconductor light emitting device, and reflects the yellow light which is mainly emitted after the wavelength of blue light is converted by the light wavelength conversion member. The optical filter thus provided can realize an efficient use of light emitted from the semiconductor light emitting device and reduce the deterioration of luminosity or luminance of light emitted from the light emitting module 40.

In this case, the optical filter has a rectangular form similar to that of the light emitting surface of the semiconductor light emitting device. Also, an opening or notch is provided such that when it is mounted on the light emitting surface of the semiconductor light emitting device, a part of the electrode communicates with the external space. Thus, even if such an optical filter is used therebetween, the arrangement described as above makes easier the placement of conductive wire and the like which are bonded on the electrode.

What is claimed is:

1. A light emitting module comprising:
a light emitting element having a light emitting surface on which a conductive portion receiving the supply of current for light emission is disposed; and
a light wavelength conversion member which is a plate-like material mounted on the light emitting surface and emits light after converting a wavelength of the light emitted by the light emitting element,
wherein the light wavelength conversion member is formed such that at least a part of the conductive portion communicates with an external space when the light wavelength conversion member is mounted on the light emitting surface.

2. A light emitting module according to claim 1, wherein the light wavelength conversion member is formed such that at least a part of the conductive portion communicates with the external space in a manner perpendicular to the light emitting surface when the light wavelength conversion member is mounted on the light emitting surface.

3. A light emitting module according to claim 1, wherein the light wavelength conversion member is formed such that at least a part of the conductive portion communicates with the external space in a manner parallel with the light emitting surface when the light wavelength conversion member is mounted on the light emitting surface.

4. A light emitting module according to claim 1, wherein the light wavelength conversion member is provided with a notch such that at least a part of the conductive portion communicates with the external space when the light wavelength conversion member is mounted on the light emitting surface.

5. A light emitting module according to claim 4, wherein the light wavelength conversion member has a corner portion, and
wherein the notch is provided in the corner portion.

6. A light emitting module according to claim 4, wherein the notch is formed such that a part of an edge of the light wavelength conversion member is recessed.

7. A light emitting module according to claim 1, wherein the light wavelength conversion member is provided with an opening running from a incident surface to a emission surface such that at least a part of the conductive portion communicates with the external space when the light wavelength conversion member is mounted on the light emitting surface.

8. A method of fabricating a light emitting module, the method comprising:
forming a light wavelength conversion member, which converts the wavelength of light emitted by a light emitting element, in such a manner that when a conductive portion receiving the supply of current for light emission is mounted on a light emitting surface of the light emitting element provided on the light emitting surface, at least a part of the conductive portion communicates with an external space; and
mounting the light wavelength conversion member on the light emitting surface in such a manner that at least a part of the conductive portion communicates with the external space.

9. A method, of fabricating a light emitting module, according to claim 8, the forming a light wavelength conversion member including:
forming a material, made of a light wavelength conversion material, in a plate-like form larger in area than the light wavelength conversion member wherein the material has openings therein; and
forming the light wavelength conversion member, in such a manner that at least a part of the conductive portion communicates with the external space through a portion that forms a part of the openings when the light wavelength conversion member is mounted on the light emitting surface of the light emitting element, by cutting the material in such a manner that a cutting surface contains the center of each of the openings.

10. A lamp unit comprising:
a light emitting module including a light emitting element having a light emitting surface on which a conductive portion receiving the supply of current for light emission is disposed, and a light wavelength conversion member which is a plate-like material mounted on the light emitting surface and emits light after converting a wavelength of the light emitted by the light emitting element; and
an optical element configured to collect the light emitted by the light emitting module,
wherein the light wavelength conversion member is formed such that at least a part of the conductive portion communicates with an external space when the light wavelength conversion member is mounted on the light emitting surface.

11. A lamp unit according to claim 10, wherein the light wavelength conversion member is formed such that at least a part of the conductive portion communicates with the external space in a manner perpendicular to the light emitting surface when the light wavelength conversion member is mounted on the light emitting surface.

12. A lamp unit according to claim 10, wherein the light wavelength conversion member is formed such that at least a part of the conductive portion communicates with the external space in a manner parallel with the light emitting surface when the light wavelength conversion member is mounted on the light emitting surface.

13. A lamp unit according to claim 10, wherein
the light wavelength conversion member is provided with a notch such that at least a part of the conductive portion communicates with the external space when the light wavelength conversion member is mounted on the light emitting surface.

14. A lamp unit according to claim 13, wherein the light wavelength conversion member has a corner portion, and wherein the notch is provided in the corner portion.

15. A lamp unit according to claim 13, wherein the notch is formed such that a part of an edge of the light wavelength conversion member is recessed.

16. A lamp unit according to claim 10, wherein the light wavelength conversion member is provided with an opening running from a incident surface to a emission surface such that at least a part of the conductive portion communicates with the external space when the light wavelength conversion member is mounted on the light emitting surface.
